(19) United States
(12) Patent Application Publication
(10) Pub. No.: US 2026/0230407 A1
(43) Pub. Date: Aug. 6, 2026

(54) TECHNIQUES FOR SCALING AN EVENT BROKER VIA TWO-WAY TRAFFIC LEARNING

(71) Applicants: Oracle International Corporation, Redwood Shores, CA (US); Indian Institute of Technology Roorkee, Roorkee (IN)

(72) Inventors: Manish Kumar Agrawal, Bangalore (IN); Sandeep Kumar, Roorkee (IN); Yogesh Kumar, Saratoga, CA (US)

(73) Assignees: Oracle International Corporation, Redwood Shores, CA (US); Indian Institute of Technology Roorkee, Roorkee (IN)

(21) Appl. No.: 19/092,926

(22) Filed: Mar. 27, 2025

(30) Foreign Application Priority Data
Feb. 5, 2025 (IN) 202541009576

(51) Int. Cl. H04L 41/5009; H04L 41/16; H04L 67/562

(52) U.S. Cl. CPC H04L 41/5012; H04L 41/16; H04L 67/562

(57) ABSTRACT

Techniques are disclosed for a scalable message broker service in a publisher-subscriber (Pub-Sub) messaging system. A message broker service executing in a computing environment of a distributed computing system can obtain quality of service metrics of the Pub-Sub messaging system. The message broker service can include a plurality of message broker instances. The message broker service can determine, based at least in part on the quality of service metrics, a number of message broker instances to send messages to subscribing clients. The message broker service can then determine whether the number of message broker instances exceeds the plurality of message broker instances and execute the number of message broker instances.

### BACKGROUND

Networked computing systems often make use of the publisher-subscriber (“Pub-Sub”) messaging paradigm for asynchronous communication. In the Pub-Sub paradigm, information can be transmitted from publishing clients to subscribing clients as messages based on various triggering conditions. The Pub-Sub paradigm can allow for rapid dissemination of information in a variety of contexts. However, the asynchronous nature of the Pub-Sub paradigm can result in network traffic inefficiencies, including reduced latencies and traffic bottlenecks in the networked computing systems.

### BRIEF SUMMARY

Embodiments of the present disclosure relate to a self-learning cloud-based broker for implementing improvements to the conventional Pub-Sub messaging paradigm for networked computing systems. In particular, distributed computing systems including cloud computing environments in which a large number (e.g., tens of thousands) of subscribing clients may receive messages from publishing clients can implement a self-learning cloud broker to improve the transmission of information (e.g., messages) from the publishing clients to the subscribing clients. The self-learning cloud broker can be composed of several instances that can scale (both out and in) to account for both the published message rate and the consumption rate of the various subscribing clients. The scaling can use detectable metrics for the outbound traffic (messages) and inbound acknowledgements of received traffic to accurately predict the demand and consumption levels of subscribing clients without requiring detailed client-level information from the subscribes.

One embodiment is directed to a method that can be performed by a message broker service executing in a computing environment, including a distributed computing system. The message broker service can obtain quality of service metrics. The message broker service can include a plurality of message broker instances. Based on the quality of service metrics, the message broker service can determine a number of message broker instances to send messages to subscribing clients. The message broker service can then determine whether the number of message broker instances exceeds the plurality of message broker instances and execute the number of message broker instances.

Another embodiment is directed to a distributed computing system comprising one or more processors and one or more memories storing instructions that, when executed by the one or more processors, cause the computing device to perform the method(s) disclosed herein.

Still another embodiment is directed to a computer-readable medium storing computer-executable instructions that, when executed by one or more processors of a computing device, cause the computing device to perform the method(s) disclosed herein.

### BRIEF DESCRIPTION OF DRAWINGS

FIG. 1 is a block diagram depicting an example computing environment with a cloud broker implementing a Pub-Sub messaging system, according to some embodiments.

FIG. 2 is a block diagram illustrating an example architecture of a Pub-Sub messaging system including a scalable cloud broker cluster within a computing environment, according to some embodiments.

FIG. 3 is a flow diagram of an example process for evaluating a number of cloud broker instances, according to some embodiments.

FIG. 4 is a flow diagram of an example process for scaling a cloud broker cluster, according to some embodiments.

FIG. 5 is a block diagram illustrating one pattern for implementing a cloud infrastructure as a service system, according to at least one embodiment.

FIG. 6 is a block diagram illustrating another pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating an example computer system, according to at least one embodiment.

### DETAILED DESCRIPTION

The present disclosure describes techniques for a self-learning cloud-based broker operating to mediate the delivery of messages within a publisher-subscriber (Pub-Sub) messaging system. The self-learning cloud broker can operate to mediate the delivery of messages from publishing clients to subscribing clients (also referred to as “publishers” and “subscribers” of the Pub-Sub messaging system, respectively). The self-learning cloud broker can be configured both to adapt the message parameters for sending batches of messages to subscribing clients and to determine the appropriate scaling of its own instances to adequately handle changes in traffic flow from the publishers and to the subscribing clients. Details of the former capability, related to adapting message parameters, is described in detail in related U.S. patent application Ser. No. 18/750,340, the entire contents of which are herein incorporated by reference in their entirety. The following description details techniques related to the second capability, scaling the cloud broker instances to address delays, latency, and event queuing between the publishers, the cloud broker, and the subscribing clients.

In a Pub-Sub messaging system, publishers can send messages on any topic, and subscribers can subscribe to the various topics to indicate that the subscriber should receive messages associated with that topic, so that the communication of information from the publisher to the subscriber occurs asynchronously. The creation of the message can be referred to as an event. Events can include, as non-limiting examples, an update to a monitored resource, a change in a stock price, the posting of new material to a social media site, a change to deployed infrastructure resource in a cloud computing environment, and the like. Publishers can send event information as messages to subscribers who have previously indicated that they should receive messages related to the event (that is to say, subscribers who have “subscribed” to events based on a topic, keyword, or other identifying information of the event). A broker system can act as an intermediary and collect the published messages. However, conventional broker systems may be insufficient to handle the scale of state of the art distributed computing systems and other cloud-based computing environments in which the number of publishers and subscribers can be enormous and can rapidly change as clients scale-up deployed computing resources to support processes, applications, and other software components that can act as both publishers and subscribers.

Conventional Pub-Sub messaging systems can be divided into two operating paradigms based on how the broker interacts with the subscribers. In the “pull model,” subscribers can initiate requests with the broker to receive messages generated by the publishers at a time suitable to the subscriber. In the “push model,” the broker pushes messages to subscribers in response to receiving the event message from the publishers. When a publisher sends a message to one or more subscribers in a Pub-Sub messaging system using the pull model, the broker can determine which of the subscribers should receive the message by, for example, using event information like a topic to match with corresponding subscribers.

In a distributed computing system like a cloud computing environment, a Pub-Sub messaging system can include numerous publishers and subscribers spread across several computing devices, including both bare metal computing devices and virtual machines (VMs), as well as user devices (e.g., personal computing devices, tablets, smartphones, etc.) that can communicate over one or more networks, including public networks like the internet. The publishers and subscribers can include applications, processes, and other software components executing on various combinations of the computing devices within the distributed computing environment. For example, a cloud service provider may provide computing resources to support a cloud application for a customer executing within a customer-specific tenancy of the computing resources. This cloud application may publish messages to be delivered to subscribing user devices (e.g., to send application data to users of the cloud application via the users' smartphones), which can be connected to the cloud computing environment over the public Internet, as well as subscribing cloud computing resources (e.g., operations computing devices monitoring the application's use of deployed resources in the cloud computing environment), which can be connected to the cloud computing environment via “internal” network connections (e.g., data center network of the cloud service provider). The flexibility of a cloud computing environment can allow the number of computing resources to change rapidly to meet customer needs, which can cause the number of publishers and subscribers to also change rapidly. In addition to the number of publishers and subscribers increasing, network latency and delay can impact the delivery of messages from the broker. If the queue of events published exceeds the rate at which the broker can handle the events and/or if the delay between delivering messages and receiving acknowledgement of the received messages increases, the broker may need to itself scale to keep up with the changing scale of publishers and subscribers.

As discussed above, the publishers and subscribers in a cloud computing environment can be varied, having different networking configurations (e.g., high-capacity Ethernet connections, 4G/5G cellular network connections, home consumer WiFi network connections) and capacity to process network traffic (e.g., an application executing on a single VM with limited compute capacity, a bare metal server device hosting a resource monitoring process, etc.). Thus, delivering event data, including messages, from the publishers to the subscribers can be sensitive to the constraints of individual subscribers. Low-frequency event delivery may be preferable for devices with limited resources or batteries, whereas high-frequency event delivery may be appropriate for robust devices with strong network connections. For example, a broker sending event data at a high rate (e.g., several large messages in a batch with short time gaps between successive messages) to one subscriber (e.g., a cloud-based digital assistant service) may be successful, while sending the event data at the same high rate to another subscriber (e.g., a cloud-based data integration service) may fail based on each subscriber's ability to successfully process the event data.

Because subscribers can include computing devices and/or computing systems with different configurations and capacity to handle incoming network traffic, the cloud broker cluster described herein can be configured to scale the number instances of the broker service that are executing within the computing environment to handle both the number of events (e.g., number of events waiting in an event queue) and any detected delays between a broker instance receiving an event and sending the corresponding message or between sending the message and receiving an acknowledgement from the subscriber. As an example, if the cloud broker cluster detects a significant increase of queued events due to an increased number of publishers, the number of broker instances can be increased to handle events in the queue at an acceptable rate. As another example, if one or more broker instances report delays between receiving an event and sending the corresponding message to subscribers, the number of broker instances can also be increased to ensure that messages are sent at an appropriate rate. And if some of the subscribers are delayed in acknowledging a message (which can delay the corresponding broker instance from handling a subsequent event), then the number of broker instances can be decreased to ensure better resource utilization and the new events in the queue are handled at an appropriate rate.

Due to the large number of publishers, subscribers, and queued events, the relationship between the size of the event queue, the message send delay, and the message acknowledgement delay from the subscribers can be complicated with respect to the optimal number of broker instances to ensure performance of the Pub-Sub system. To account for this complexity, the cloud broker cluster can optimize a scaling model to predict the number of cloud broker instances based on the current event queue and the measured delays for sending messages and receiving acknowledgements. For example, the cloud broker cluster can determine the current number of events in the event queue (e.g., the number of events generated by publishers but not yet handled by the cloud broker cluster), an event delay time (e.g., the time delay between a cloud broker instance receiving an event in the queue and sending the corresponding message), and a subscriber response time (e.g., the time delay between a cloud broker instance sending a message to a subscriber and receiving an acknowledgement of the message delivery). The cloud broker cluster can then evaluate a number of cloud broker instances that is optimal for handling the event queue and the current latencies of both the existing cloud broker instances and the subscribers in the Pub-Sub system. This determination can be repeated at successive time steps (e.g., every 10 s, every minute, etc.) to continually adapt the number of executing cloud broker instances to handle the evolving state of publishers and subscribers. In addition, the model parameters used in the scaling model (e.g., weights) can be updated at each time step to track the model's response to the cloud broker cluster's performance. Collectively, the queue size, the message send delay, and the message acknowledgement delay can be quality of service (QoS) metrics that represent the responsiveness of the Pub-Sub system to events.

The techniques described herein can provide numerous advantages over conventional Pub-Sub messaging systems. For example, a scalable cloud broker can adjust itself to changes in the queuing latency and message send/acknowledge latency to overcome bottlenecks in network traffic in two directions. If the event queue becomes too large (due to increased number of Publishers or an increase in event frequency), the cloud broker cluster can scale out to ensure enough broker instances to handle the queue. Similarly, if one or more of the broker instances are delayed in either sending messages or waiting on responses from the Subscribers, the cloud broker cluster can scale to ensure sufficient capacity to handle queued events. In addition, the scalable cloud broker can reduce excess, wasted, or inefficiently allocated computing resources to the cloud broker cluster by reducing the number of executing broker instances when the cloud broker cluster is sufficiently handling queued events or the message delivery latency. Moreover, the cloud broker cluster reevaluates the predicted number broker instances to handle future events and continually retrains its model parameters, thereby ensuring accurate modeling as the cloud broker adjusts to handle changes to the Pub-Sub environment. Because the model evaluations are automatic, the techniques described herein minimize the amount of manual tuning or configuration of the scalable cloud broker.

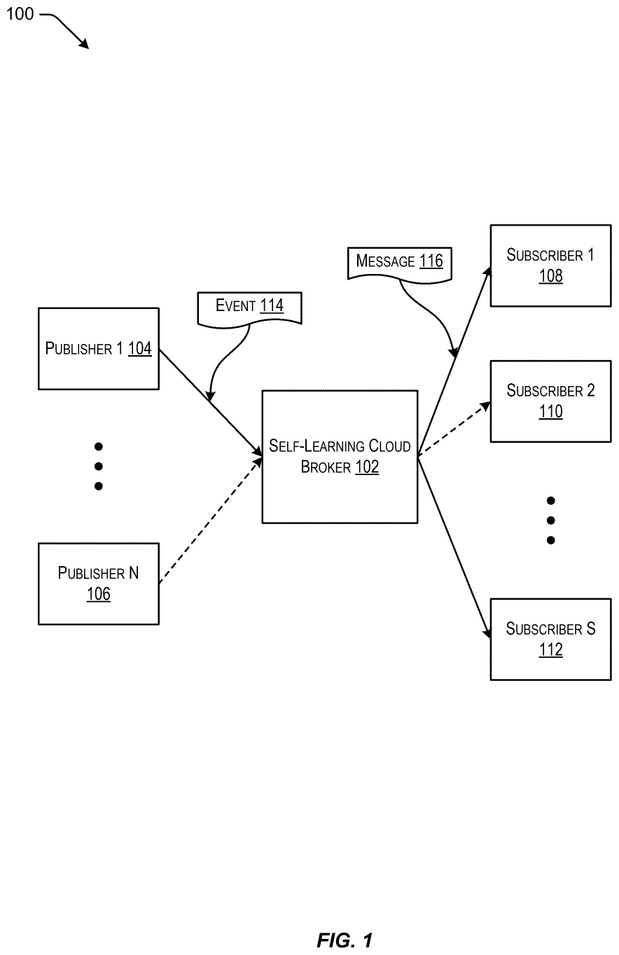

Turning now to the figures, FIG. 1 is a block diagram depicting an example computing environment 100 with a self-learning cloud broker 102 implementing a Pub-Sub messaging system, according to some embodiments. Self-learning cloud broker 102 can include a cloud broker cluster having a plurality of instances executing on one or more computing devices of the computing environment 100. The computing environment 100 can be an example of a cloud computing environment or other distributed computing system (e.g., client/server system) in which multiple computing, networking, and storage devices operate in conjunction to create the computing environment 100. For example, various computing devices, including bare metal server device and VMs, can be configured to execute software (e.g., code, instructions, programs) on one or more processors of the computing devices or combinations thereof to implement the computing environment 100. In the context of a Pub-Sub messaging system, publishing clients (“publishers”) and subscribing clients (“subscribers”) can include applications, programs, processes, and the like executing on one or more of the computing device of the computing environment 100. For example, publisher 1 104 may be an example of a cloud based application executing on multiple VMs within the computing environment 100, while subscriber 2 110 may be an example of a user application executing at a user device (e.g., a smartphone) that can access cloud computing resources over a public internet.

The self-learning cloud broker 102 can be implemented on one or more computing devices within the computing environment 100. In some examples, the self-learning cloud broker 102 can be implemented within a cloud computing environment that operates within one or more data centers of a cloud service provider, in which each data center can include multiple bare metal server devices and associated networking and storage devices to enable to cloud computing environment. In these examples, the self-learning cloud broker 102 can be a cloud-based service and can communicate with other computing devices and/or software components via one or more network connections (e.g., internal data center network connections, private network connections, public network connections like the Internet, etc.). In other examples, the self-learning cloud broker 102 can execute on a single device, including a single server device or singe VM, as appropriate.

As depicted in in FIG. 1, the self-learning cloud broker 102 can be configured to mediate the delivery of messages (e.g., message 116) that include event data generated by publishers and intended to be delivered to one or more subscribers. For example, self-learning cloud broker 102 can mediate message delivery between N number of publishers including Publisher 1 104 through Publisher N 106 and S number of subscribers including Subscriber 1 108, Subscriber 2 110, and Subscriber S 112. The self-learning cloud broker 102 can maintain the subscription information for each of the S subscribers. For example, Subscriber 1 108 can subscribe to a topic corresponding to an uptime status change of a computing resource in the computing environment 100. Publisher 1 104 may be a process that monitors the computing resource and provides event information to the self-learning cloud broker 102 when the uptime of the computing resource changes (e.g., the computing resource goes offline). Then, in this example, Subscriber 1 108 can receive one or more messages including event information for the change in the uptime of the computing resource when that event information is published by Publisher 1 104. Subscribers can subscribe to one or more topics, and publishers can publish event information for one or more topics. The self-learning cloud broker 102 can maintain the subscription information in a database or other storage (not shown) accessible to the self-learning cloud broker 102. The self-learning cloud broker 102 can update the subscription information as the number of publishers and subscribers increases and/or decreases or as existing subscribers modify their existing subscriptions to topics.

Not all topics may be subscribed to by all S subscribers. For example, Publisher 1 104 can publish an event 114 to self-learning cloud broker 102. The event 114 can include information that determines to which subscribers the event information should be delivered as a message. For example, the event 114 can include the topic (e.g., as a keyword, tag, channel identifier, or other identifier). The self-learning cloud broker 102 can use the information to determine the subscribers to which the corresponding messages should be delivered. In the example, event 114 can include information indicating a topic to which Subscriber 1 108 and Subscriber S 112 are subscribed (indicated by the solid arrows), but to which Subscriber 2 110 is not subscribed (indicated by the dashed arrow). The self-learning cloud broker 102 can then send a message 116 to Subscriber 1 108 (and a corresponding message to Subscriber S 112, not shown), but no message may be sent to Subscriber 2 110.

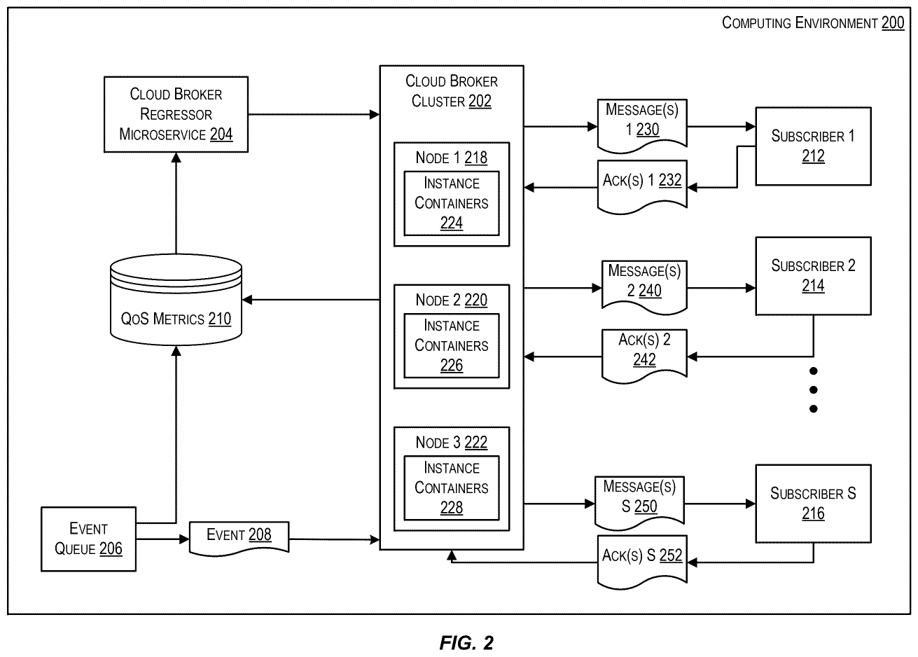

FIG. 2 is a block diagram illustrating an example architecture of a Pub-Sub messaging system including a scalable cloud broker cluster 202 within a computing environment 200, according to some embodiments. The computing environment 200 may be an example of computing environment 100 of FIG. 1. The cloud broker cluster 202 can work in conjunction with a cloud broker regressor microservice 204, which may be components of the self-learning cloud broker 102 of FIG. 1.

The cloud broker cluster 202 can include a cluster of nodes within the computing environment 200. Each node may be a computing device of the computing environment 200, including a virtual machine executing on a bare metal computing device. As depicted in FIG. 2, cloud broker cluster 202 can include node 1 218, node 2 220, and node 3 222, although more or fewer nodes may be used for the cloud broker cluster 202. The cloud broker cluster can include a plurality of cloud broker instances that execute within the nodes. An instance in this context refers to a replica of the cloud broker application and/or processes, with each cloud broker instance capable of performing the operations of the cloud broker within the Pub-Sub messaging system. For example, an instance of the cloud broker can receive events, generate corresponding message(s), send the message(s) to one or more Subscribers, measure latency between event receipt, message send, and acknowledgement receipt, and report these measured values to other components of the Pub-Sub message system. Each node can include one or more of the cloud broker instances. In some examples, each instance may execute within a container managed by a containerization engine (e.g., Kubernetes), with each node hosting one or more instance containers. For example, node 1 218 may host instance containers 224, node 2 220 may host instance containers 226, and node 3 222 may host instance containers 228.

Within the cloud broker cluster 202, each node may support a maximum number of containers depending on the computing resources available to each node and the system used to manage the instance deployment. For example, for a cloud broker cluster 202 managed using Kubernetes, each node may support 110 pods of instance containers, with each pod including typically a single container. When the cloud broker cluster 202 executes additional broker instances, the new instances may be executed on a node that can support additional instance containers. For example, if the instance containers 224 of Node 1 218 already include the maximum 110 pods, then additional cloud broker instances may be executed in containers of instance containers 226 of Node 2 220. If all of the current nodes of the cloud broker cluster 202 have reached their maximum supported number of instance containers, then the cloud broker cluster 202 can provision additional nodes within the cluster. For example, a VM can be provisioned within the cloud broker cluster 202 to host a fourth node and additional instance containers. Similarly, if the number of instances within the cloud broker cluster 202 can be reduced, then instances can be terminated on a node such that the node can be decommissioned to free computing resources within the computing environment 200.

In the Pub-Sub messaging system of FIG. 2, the cloud broker cluster 202 can receive an event 208 from an event queue 206. The event 208 can include event information, including a topic or other identifier usable to determine subscribers to which messages should be sent to transmit the event information. The event queue 206 can be a queue of events from publishing clients of the Pub-Sub messaging system (e.g., Publisher 1 104 of FIG. 1). In response to receiving the event 208, the cloud broker cluster 202 can identify which subscribers to send corresponding messages. For example, the cloud broker cluster 202 can determine that each of Subscriber 1 210, Subscriber 2 212, and Subscriber S 214 should receive corresponding message(s) 1 220, message(s) 2 230, and message(s) 3 240, respectively. An individual message may conform to one of several data architectures, including representational state transfer (REST) or remote procedure call (RPC), and may be formatted as an HTML, XML, JSON, or similar document. The message can include fields for data related to and/or describing the event information, including attributes, timestamp, identifiers, and a data payload. After receiving corresponding messages, each Subscriber can reply to the cloud broker cluster 202 with a corresponding acknowledgement indicating a successful receipt of the message. For example, Subscriber 1 212 can respond to each of message(s) 1 230 with corresponding ack(s) 1 232, Subscriber 2 214 can respond to each of message(s) 2 240 with corresponding ack(s) 2 242, and Subscriber S 216 can respond to each of message(s) S 250 with ack(s) S 252. The acknowledgements can be sent back to the broker instance that sent the corresponding message.

The broker instance in the cloud broker cluster 202 that handles event 208 can track the time between receiving event 208 from the event queue 206 and sending the corresponding message (message send delay) as well as the time between sending the corresponding message and receiving a corresponding acknowledgement (message acknowledgement delay). The time delays can be determined from timestamps associated with the events, messages, and acknowledgements. The message send delay and the message acknowledgement delay can be aggregated as QoS metrics 210, which may be stored within computing environment 200. In some examples, the reported message send delays and message acknowledgement delays from each of the broker instances of the cloud broker cluster 202 can be averaged over a given interval. For example, if the interval is one minute, then the message send delays for each message sent within the one minute interval can be averaged to determine an average message send delay, which can be stored as a QoS metric 210. For successive intervals, the average can be recomputed and the corresponding metric of the QoS metrics 210 can be updated.

The cloud broker cluster 202 can be scaled in accordance with an evaluation done by cloud broker regressor microservice 204. The cloud broker regressor microservice 204 can be service that performs operations using a scaling model to determine the predicted optimal number of broker instances within cloud broker cluster 202. The cloud broker regressor microservice 204 can execute on a computing device within computing environment 200, including a VM.

The cloud broker regressor microservice 204 can determine the number of cloud broker instances using a scaling model. The scaling model can include a cost function that characterizes the response of the Pub-Sub system to the current QoS metrics 210. In some embodiments, the cost function can be given as:

$$C ( t ) = {w}_{1} \cdot Q ( t ) + {w}_{2} \cdot D ( t ) - {w}_{3} \cdot A ( t ) ,$$

where Q(t) represents the number of events in event queue 206 at time t, D(t) represents the message send delay within the cloud broker cluster 202 at time t (e.g., the average message send delay of the broker instances), A (t) represents the message acknowledgement delay within the cloud broker cluster 202 at time t (e.g., the average message acknowledgement delay), and w₁, w₂, and w₃ are weights for each of the QoS metrics 210. In one example, the weights may be set initially as w₁=0.5, w₂=0.3, and w₃=0.2, representing the relative importance of the contribution of each QoS metric to the cost (e.g., a larger number of events in the event queue 206 is relatively more detrimental to the Pub-Sub system than the message send delay). The weights can be updated for each time interval. The time “t” can represent a current interval for evaluating the cost function. In some examples, the interval can be short (e.g., 1 second), so that the cost function represents real time or near real time values derived from the QoS metrics 210. In some examples, the cloud broker regressor microservice 204 can poll the QoS metrics 210 at the interval when performing the scaling model operations.

Determining the number of cloud broker instances to execute within the cloud broker cluster 202 can include minimizing the cost function C(t) subject to constraints. The constraints can include maximum values for each of the QoS metrics 210. For example, there may be a maximum allowable queue size Q for the event queue 206, a maximum allowable message send delay D, and a maximum allowable message acknowledgement delay A. In addition, the number of executing instances N(t) may be constrained by both a minimum number of instances Nₘᵢₙ and a maximum allowable number of instances Nₘₐₓ. These maximum and minimum allowable values may be set by service level agreements that define the performance of the Pub-Sub system.

Prior to performing predictions, the cloud broker regressor microservice 204 can initially train the scaling model on training data similar to the QoS metrics 210. For example, synthetic training data can be generated based on the observed or expected response of a Pub-Sub system to different values of Q, D, A, and N. This synthetic training data can include added noise to simulate uncertainty in measurements provided within the Pub-Sub system (e.g., inaccuracy in measured delays). For the training, the cloud broker regressor microservice 204 can perform a least squares linear regression on the data to produce a trained scaling model.

Once trained, the cloud broker regressor microservice 204 can then predict the number of cloud broker instances for the Pub-Sub system based on the current QoS metrics 210. For a current number of cloud broker instances N(t) executing in the cloud broker cluster 202, the cloud broker regressor microservice 204 predict the number of cloud broker instances N(t+1) for the next time interval by performing gradient descent:

$$\begin{matrix}Δ N ( t ) = - η ( \frac{\partial C ( t )}{\partial Q ( t )} \cdot \frac{dQ ( t )}{dN ( t )} + \frac{\partial C ( t )}{\partial D ( t )} \cdot \frac{dD ( t )}{dN ( t )} - \frac{\partial C ( t )}{\partial A ( t )} \cdot \frac{dA ( t )}{dN ( t )} ) \\ = - η ( {w}_{1} \cdot \frac{dQ ( t )}{dN ( t )} + {w}_{2} \cdot \frac{dD ( t )}{dN ( t )} - {w}_{3} \cdot \frac{dA ( t )}{dN ( t )} ) ,\end{matrix}$$

where η is a learning rate parameter that characterizes the size of adjustments for each time step. The parameter η controls the size of the steps taken to reach the minimum value of the cost function C(t). A smaller η results in smaller steps, making convergence to the minimum slower but safer. A larger n speeds up convergence but may overshoot the minimum. To perform the gradient descent, the cloud broker regressor microservice 204 can compute the derivatives present in the expression for ΔN(t) using the trained scaling model and the current values of the QoS metrics 210 (Q(t), D(t), A(t)). Since the trained scaling model was trained using linear regression, the model coefficients, updated with the current QoS metrics 210 and the current number of instances N(t), will correspond to the derivatives of the QoS metrics with respect to N(t)

$$( e . g . , \frac{dQ ( t )}{dN ( t )} , \frac{dD ( t )}{dN ( t )} , \frac{dA ( t )}{dN ( t )} ) .$$

Then, the predicted change in the number of cloud broker instances ΔN(t) can be computed according to the expression above. The number of cloud broker instances that should be executing based on the current QoS metrics 210 is then N(t+1)=N(t)+ΔN(t). If ΔN(t) is positive, the cloud broker cluster 202 can scale out by executing an additional ΔN(t) cloud broker instances. If ΔN(t) is negative, then the cloud broker cluster 202 can scale in by removing ΔN(t) cloud broker instances.

In addition to updating the scaling model coefficients with the current QoS metrics 210 measured by the cloud broker cluster 202, the weights of the cost function can be updated at each time interval. The update of the weights can also be done using gradient descent. For example, for weight parameters represented as θ=[w₁, w₂, w₃], then updated weight parameters can be given as θ_{new}=θ_{old}-η∇_{θ}C(t), where η is the same learning parameter as above. The gradient is then

$${∇}_{θ} C ( t ) = [ \frac{dQ ( t )}{dN ( t )} \cdot Q ( t ) , \frac{dD ( t )}{dN ( t )} \cdot D ( t ) , \frac{dA ( t )}{dN ( t )} \cdot A ( t ) ] , where \frac{dQ ( t )}{dN ( t )} , \frac{dD ( t )}{dN ( t )} , \frac{dA ( t )}{dN ( t )}$$

are the current model coefficients. In this way, the weights are updated at each time interval along with the scaling model coefficients in response to the QoS metrics 210.

Once the cloud broker regressor microservice 204 determine the number of cloud broker instances to execute, the cloud broker regressor microservice 204 can provide that information to the cloud broker cluster 202. The cloud broker cluster 202 can then execute additional cloud broker instances or remove excess cloud broker instances to ensure that the total number of cloud broker instances executing in the computing environment 200 is optimized to handle the event queue 206 and the delays in message send and message acknowledgements.

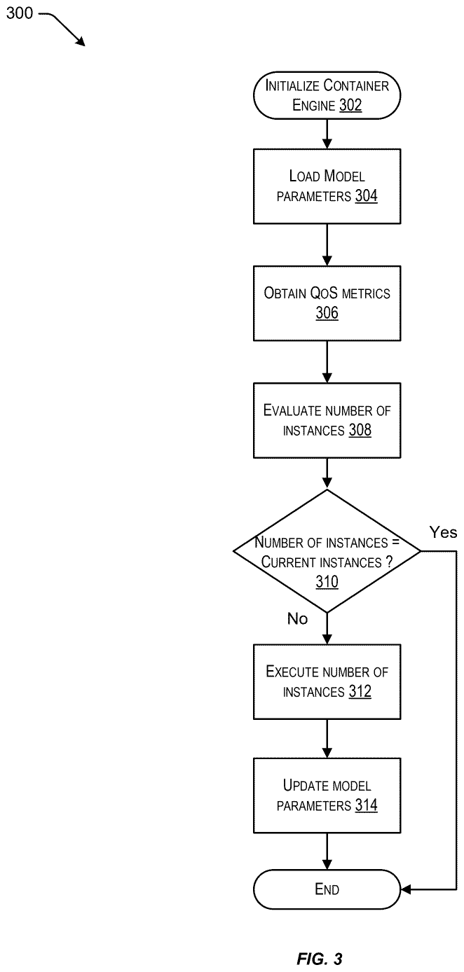

FIG. 3 is a flow diagram of an example process 300 for evaluating a number of cloud broker instances, according to some embodiments. The process 300 may be performed by one or more components of a distributed computing system, including a scalable cloud broker executing in a computing environment (e.g., computing environment 200 of FIG. 2), including a cloud computing environment. In some embodiments, a computer-readable medium comprising computer-readable instructions that, upon execution by one or more processors of a distributed computing system, can cause the distributed computing system to perform the process 300. The operations of process 300 may be performed in any suitable order, and process 300 may include more or fewer operations than those depicted in FIG. 3.

Some or all of the process 300 (or any other processes and/or methods described herein, including process 400, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The process 300 can begin at start point 302, where the container engine for the Pub-Sub messaging system is initialized. The container engine can be configured to manage the execution environment (e.g., containers) for a plurality of cloud broker instances of a cloud broker cluster (e.g., cloud broker cluster 202 of FIG. 2). As one example of a container engine, Kubernetes may be used to manage both the containers (e.g., instance containers 224-228 of FIG. 2) and the nodes (e.g., Nodes 1-3 218-222 of FIG. 2) of the cloud broker cluster. The container engine may operate in conjunction with the control plane of one or more services responsible for deploying additional nodes (e.g., a hypervisor for VMs) to support scaling the cloud broker cluster. Initializing the container engine can include establishing an initial state for the cloud broker cluster. For example, upon initialization a default number of containers and corresponding cloud broker instances may be executed on one or more nodes in the cluster. These default parameters for the cloud broker cluster can be preconfigured for the initialization based on the anticipated initial workload of the Pub-Sub messaging system.

At block 304, the scalable cloud broker, or a component thereof (e.g., cloud broker regressor microservice 204 of FIG. 2), can load model parameters. The model parameters can include values determined from an initial training of a scaling model. For example, coefficients of a least squares linear regression on synthetic QoS values can be loaded as the model parameters. The model parameters can also include weights for each of the QoS metrics for use in a cost function.

At block 306, the scalable cloud broker can obtain QoS metrics (e.g., QoS metrics 210 of FIG. 2). The QoS metrics can include the current values for the number of events in an event queue, a message send delay, and a message acknowledgement delay. “Current” values may be the values most recently updated by the cloud broker cluster for a time interval.

At block 308, the scalable cloud broker can evaluate the number of cloud broker instances that should execute in the cloud broker cluster. To evaluate the number of cloud broker instances, the scalable cloud broker can predict the optimal change in the number of cloud broker instances based on the current QoS metrics and trained model parameters. As described above with respect to FIG. 2, predicting the optimal change

$$Δ N ( t ) = - η ( {w}_{1} \cdot \frac{dQ ( t )}{dN ( t )} + {w}_{2} \cdot \frac{dD ( t )}{dN ( t )} - {w}_{3} \cdot \frac{dA ( t )}{dN ( t )} )$$

can include evaluating a weighted sum of the predicted response of each QoS metric with respect to the change in the number of cloud broker instances executing in the cloud broker cluster.

At decision 310, the scalable cloud broker can determine if the evaluated number of cloud broker instances is equal to the current number of executing cloud broker instances in the cloud broker cluster. If ΔN(t) is zero, than the number of instances will be equal to the current instances in the cluster, indicating that the cloud broker cluster should make no changes, and the process 300 can proceed to the end point. If ΔN(t) is non-zero, than the number of instances will be different than the current instances in the cluster, indicating that the cloud broker cluster should be scaled in or out as appropriate.

At block 312, the scalable cloud broker can execute the number of cloud broker instances. Executing the number of cloud broker instances can include executing ΔN(t) additional cloud broker instances or removing ΔN(t) excess cloud broker instances. When executing additional cloud broker instances, the scalable cloud broker can instruct the container engine to deploy additional containers for the additional instances within the pods executing on the one or more nodes of the cloud broker cluster. In some embodiments, the additional cloud broker instances can be executed on existing nodes. In some embodiments, one or more additional nodes may be provisioned to host the containers for the additional cloud broker instances.

At block 314, the scalable cloud broker can update the model parameters. The model parameters that are updated can include the weights used in the cost function. Updating the model parameters can also occur by gradient descent. For example, the new (updated) weights can be determined with θ_{new}=θ_{old}−η∇_{θ}C(t), by evaluating the gradient of the cost function.

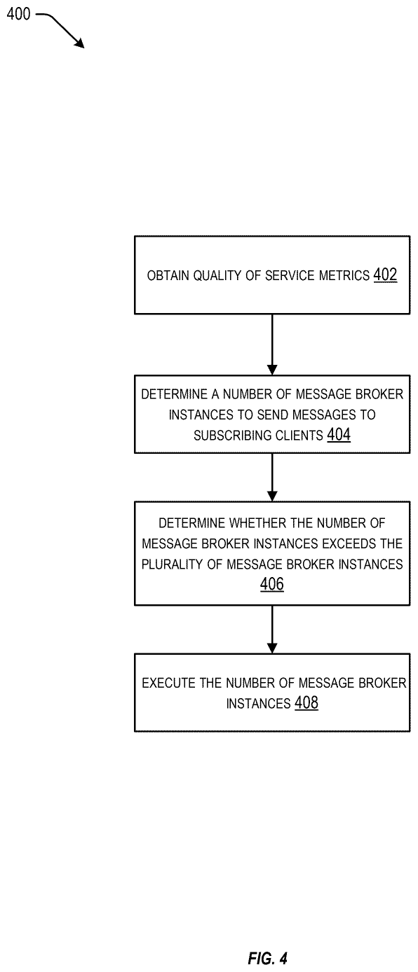

FIG. 4 is a flow diagram of an example process 400 for scaling a cloud broker cluster, according to some embodiments. The cloud broker cluster may be an example of cloud broker cluster 202 of FIG. 2. The process 400 can be performed by a message broker service like the scalable cloud broker described herein, including the cloud broker cluster and associated components like a cloud broker regressor microservice (e.g. cloud broker regressor microservice 204 of FIG. 2) executing within a distributed computing system. In some embodiments, a computer-readable medium comprising computer-readable instructions that, upon execution by one or more processors of a distributed computing system, can cause the distributed computing system to perform the process 400. The operations of process 400 may be performed in any suitable order, and process 400 may include more or fewer operations than those depicted in FIG. 4.

Process 400 may begin at block 402, with the message broker service obtaining quality of service (QoS) metrics. The QoS metrics (e.g., QoS metrics 210 of FIG. 2) can include a number of events (message queue value) in an event queue (event queue 206 of FIG. 2), a delay between cloud broker instances receiving an event from the queue and sending a corresponding message to a Subscriber (message send delay value), and a delay between sending a message and receiving a corresponding acknowledgement from the Subscriber (message acknowledgement delay value). The message broker service can include a plurality of message broker instances. For example, replicas of the message broker service can execute in a plurality of containers managed by a container engine, with the containers hosted on one or more computing cluster nodes (e.g., Node 1 218 of FIG. 2) of the distributed computing system.

At block 404, the message broker service can determine a number of message broker instances (e.g., cloud broker instances) to send messages to subscribing clients. The number of message broker instances can be the same as or different from the current number of the plurality of message broker instances executing in the distributed computing environment. Determining the number of message broker instances can include minimizing a cost function using an optimization technique with a trained scaling model. The cost function can take the QoS metrics as inputs. In some embodiments, the optimization technique can be gradient descent. The change in the number of message broker instances can be determined from a weighted sum of model parameters including coefficients of the trained scaling model that characterize the relationship between the QoS metrics and the number of message broker instances.

At block 406, the message broker service can determine whether the number of message broker instances exceeds the plurality of message broker instances. For example, if the predicted number of message broker instances exceeds the current number of executing message broker instances, then the message broker service may be “overloaded” and may need to scale out to handle the queued events or delays in generating messages or receiving acknowledgements from the subscribers.

At block 408, the message broker service can execute the number of message broker instances. Executing the number of message broker instances can include either executing additional message broker instances or removing excess message broker instances. In some embodiments, executing the number of message broker instances can be based on a determination that the number of message broker instances exceeds the plurality of message broker instances. In some embodiments, executing the number of message broker instances can be based on a determination that the number of message broker instances falls below the plurality of message broker instance.

In some embodiments, the operations of blocks 402-408 can be repeated at successive time intervals. The time interval can be a length of time for which the evaluation of the scaling model using the QoS metrics is to be performed. In some examples, the time interval can be less than 1 second, 1 second, 1 minute, 5 minutes, or the like. By repeating the operations of process 400 at each time interval, the message broker service can be continuously adapted and scaled to optimize performance when handling events in the Pub-Sub system.

In some embodiments, the model parameters of the scaling model can be updated at each time interval. The model parameters can include one or more weight values of the cost function. The model parameters can be updated using gradient descent using the QoS metrics.

### Example Infrastructure as a Service Architectures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model may require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed may need to first be set up. In some instances, the provisioning can be done manually, a provisioning tool may be utilized to provision the resources, and/or deployment tools may be utilized to deploy the code once the infrastructure is provisioned.

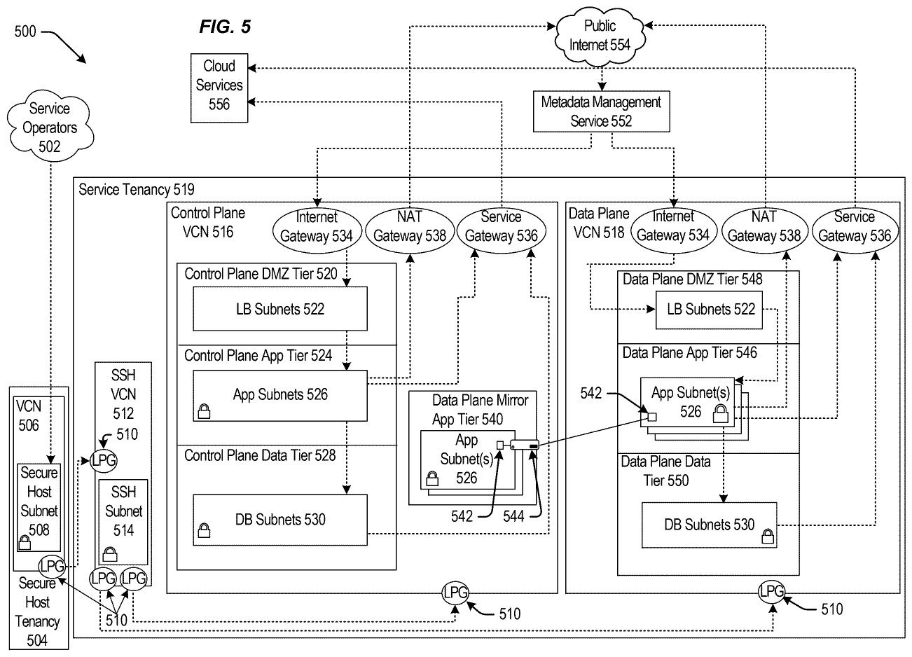

FIG. 5 is a block diagram 500 illustrating an example pattern of an IaaS architecture, according to at least one embodiment. Service operators 502 can be communicatively coupled to a secure host tenancy 504 that can include a virtual cloud network (VCN) 506 and a secure host subnet 508. In some examples, the service operators 502 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 contained in the SSH VCN 512. The SSH VCN 512 can include an SSH subnet 514, and the SSH VCN 512 can be communicatively coupled to a control plane VCN 516 via the LPG 510 contained in the control plane VCN 516. Also, the SSH VCN 512 can be communicatively coupled to a data plane VCN 518 via an LPG 510. The control plane VCN 516 and the data plane VCN 518 can be contained in a service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530 (e.g., frontend DB subnet(s) and/or backend DB subnet(s)). The LB subnet(s) 522 contained in the control plane DMZ tier 520 can be communicatively coupled to the app subnet(s) 526 contained in the control plane app tier 524 and an Internet gateway 534 that can be contained in the control plane VCN 516, and the app subnet(s) 526 can be communicatively coupled to the DB subnet(s) 530 contained in the control plane data tier 528 and a service gateway 536 and a network address translation (NAT) gateway 538. The control plane VCN 516 can include the service gateway 536 and the NAT gateway 538.

The control plane VCN 516 can include a data plane mirror app tier 540 that can include app subnet(s) 526. The app subnet(s) 526 contained in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be contained in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management service 552 that can be communicatively coupled to public Internet 554. Public Internet 554 can be communicatively coupled to the NAT gateway 538 of the control plane VCN 516 and of the data plane VCN 518. The service gateway 536 of the control plane VCN 516 and of the data plane VCN 518 can be communicatively coupled to cloud services 556.

In some examples, the service gateway 536 of the control plane VCN 516 or of the data plane VCN 518 can make application programming interface (API) calls to cloud services 556 without going through public Internet 554. The API calls to cloud services 556 from the service gateway 536 can be one-way: the service gateway 536 can make API calls to cloud services 556, and cloud services 556 can send requested data to the service gateway 536. But, cloud services 556 may not initiate API calls to the service gateway 536.

In some examples, the secure host tenancy 504 can be directly connected to the service tenancy 519, which may be otherwise isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the service tenancy 519.

The control plane VCN 516 may allow users of the service tenancy 519 to set up or otherwise provision desired resources. Desired resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be contained in the data plane mirror app tier 540 and the data plane app tier 546.

In some examples, users of the system, or customers, can make requests, for example create, read, update, or delete (CRUD) operations, through public Internet 554 that can communicate the requests to the metadata management service 552. The metadata management service 552 can communicate the request to the control plane VCN 516 through the Internet gateway 534. The request can be received by the LB subnet(s) 522 contained in the control plane DMZ tier 520. The LB subnet(s) 522 may determine that the request is valid, and in response to this determination, the LB subnet(s) 522 can transmit the request to app subnet(s) 526 contained in the control plane app tier 524. If the request is validated and requires a call to public Internet 554, the call to public Internet 554 may be transmitted to the NAT gateway 538 that can make the call to public Internet 554. Metadata that may be desired to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to configuration may be desired to be applied to the resources contained in the data plane VCN 518. Via a VNIC 542, the control plane VCN 516 can directly communicate with, and can thereby execute the changes, updates, or other suitable modifications to configuration to, resources contained in the data plane VCN 518.

In some embodiments, the control plane VCN 516 and the data plane VCN 518 can be contained in the service tenancy 519. In this case, the user, or the customer, of the system may not own or operate either the control plane VCN 516 or the data plane VCN 518. Instead, the IaaS provider may own or operate the control plane VCN 516 and the data plane VCN 518, both of which may be contained in the service tenancy 519. This embodiment can enable isolation of networks that may prevent users or customers from interacting with other users', or other customers', resources. Also, this embodiment may allow users or customers of the system to store databases privately without needing to rely on public Internet 554, which may not have a desired level of threat prevention, for storage.

In other embodiments, the LB subnet(s) 522 contained in the control plane VCN 516 can be configured to receive a signal from the service gateway 536. In this embodiment, the control plane VCN 516 and the data plane VCN 518 may be configured to be called by a customer of the IaaS provider without calling public Internet 554. Customers of the IaaS provider may desire this embodiment since database(s) that the customers use may be controlled by the IaaS provider and may be stored on the service tenancy 519, which may be isolated from public Internet 554.

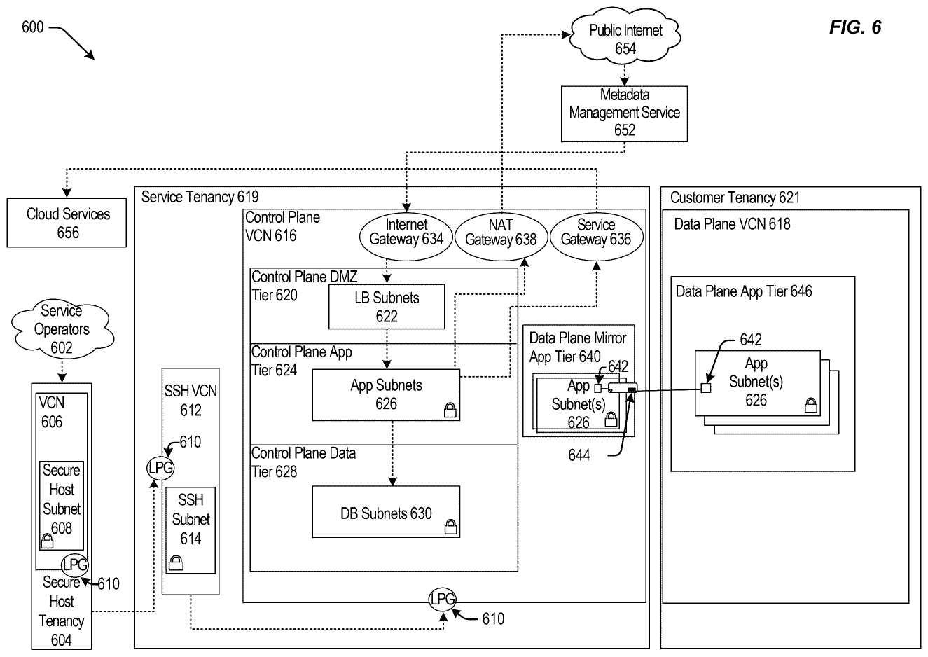

FIG. 6 is a block diagram 600 illustrating another example pattern of an IaaS architecture, according to at least one embodiment. Service operators 602 (e.g., service operators 502 of FIG. 5) can be communicatively coupled to a secure host tenancy 604 (e.g., the secure host tenancy 504 of FIG. 5) that can include a virtual cloud network (VCN) 606 (e.g., the VCN 506 of FIG. 5) and a secure host subnet 608 (e.g., the secure host subnet 508 of FIG. 5). The VCN 606 can include a local peering gateway (LPG) 610 (e.g., the LPG 510 of FIG. 5) that can be communicatively coupled to a secure shell (SSH) VCN 612 (e.g., the SSH VCN 512 of FIG. 5) via an LPG 510 contained in the SSH VCN 612. The SSH VCN 612 can include an SSH subnet 614 (e.g., the SSH subnet 514 of FIG. 5), and the SSH VCN 612 can be communicatively coupled to a control plane VCN 616 (e.g., the control plane VCN 516 of FIG. 5) via an LPG 610 contained in the control plane VCN 616. The control plane VCN 616 can be contained in a service tenancy 619 (e.g., the service tenancy 519 of FIG. 5), and the data plane VCN 618 (e.g., the data plane VCN 518 of FIG. 5) can be contained in a customer tenancy 621 that may be owned or operated by users, or customers, of the system.

The control plane VCN 616 can include a control plane DMZ tier 620 (e.g., the control plane DMZ tier 520 of FIG. 5) that can include LB subnet(s) 622 (e.g., LB subnet(s) 522 of FIG. 5), a control plane app tier 624 (e.g., the control plane app tier 524 of FIG. 5) that can include app subnet(s) 626 (e.g., app subnet(s) 526 of FIG. 5), a control plane data tier 628 (e.g., the control plane data tier 528 of FIG. 5) that can include database (DB) subnet(s) 630 (e.g., similar to DB subnet(s) 530 of FIG. 5). The LB subnet(s) 622 contained in the control plane DMZ tier 620 can be communicatively coupled to the app subnet(s) 626 contained in the control plane app tier 624 and an Internet gateway 634 (e.g., the Internet gateway 534 of FIG. 5) that can be contained in the control plane VCN 616, and the app subnet(s) 626 can be communicatively coupled to the DB subnet(s) 630 contained in the control plane data tier 628 and a service gateway 636 (e.g., the service gateway 536 of FIG. 5) and a network address translation (NAT) gateway 638 (e.g., the NAT gateway 538 of FIG. 5). The control plane VCN 616 can include the service gateway 636 and the NAT gateway 638.

The control plane VCN 616 can include a data plane mirror app tier 640 (e.g., the data plane mirror app tier 540 of FIG. 5) that can include app subnet(s) 626. The app subnet(s) 626 contained in the data plane mirror app tier 640 can include a virtual network interface controller (VNIC) 642 (e.g., the VNIC of 542) that can execute a compute instance 644 (e.g., similar to the compute instance 544 of FIG. 5). The compute instance 644 can facilitate communication between the app subnet(s) 626 of the data plane mirror app tier 640 and the app subnet(s) 626 that can be contained in a data plane app tier 646 (e.g., the data plane app tier 546 of FIG. 5) via the VNIC 642 contained in the data plane mirror app tier 640 and the VNIC 642 contained in the data plane app tier 646.

The Internet gateway 634 contained in the control plane VCN 616 can be communicatively coupled to a metadata management service 652 (e.g., the metadata management service 552 of FIG. 5) that can be communicatively coupled to public Internet 654 (e.g., public Internet 554 of FIG. 5). Public Internet 654 can be communicatively coupled to the NAT gateway 638 contained in the control plane VCN 616. The service gateway 636 contained in the control plane VCN 616 can be communicatively coupled to cloud services 656 (e.g., cloud services 556 of FIG. 5).

In some examples, the data plane VCN 618 can be contained in the customer tenancy 621. In this case, the IaaS provider may provide the control plane VCN 616 for each customer, and the IaaS provider may, for each customer, set up a unique compute instance 644 that is contained in the service tenancy 619. Each compute instance 644 may allow communication between the control plane VCN 616, contained in the service tenancy 619, and the data plane VCN 618 that is contained in the customer tenancy 621. The compute instance 644 may allow resources, that are provisioned in the control plane VCN 616 that is contained in the service tenancy 619, to be deployed or otherwise used in the data plane VCN 618 that is contained in the customer tenancy 621.

In other examples, the customer of the IaaS provider may have databases that live in the customer tenancy 621. In this example, the control plane VCN 616 can include the data plane mirror app tier 640 that can include app subnet(s) 626. The data plane mirror app tier 640 can reside in the data plane VCN 618, but the data plane mirror app tier 640 may not live in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity contained in the control plane VCN 616. The customer may desire to deploy or otherwise use resources in the data plane VCN 618 that are provisioned in the control plane VCN 616, and the data plane mirror app tier 640 can facilitate the desired deployment, or other usage of resources, of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, contained in the customer tenancy 621, can help isolate the data plane VCN 618 from other customers and from public Internet 654.

In some embodiments, cloud services 656 can be called by the service gateway 636 to access services that may not exist on public Internet 654, on the control plane VCN 616, or on the data plane VCN 618. The connection between cloud services 656 and the control plane VCN 616 or the data plane VCN 618 may not be live or continuous. Cloud services 656 may exist on a different network owned or operated by the IaaS provider. Cloud services 656 may be configured to receive calls from the service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 1,” and cloud service “Deployment 5,” may be located in Region 1 and in “Region 2.” If a call to Deployment 5 is made by the service gateway 636 contained in the control plane VCN 616 located in Region 1, the call may be transmitted to Deployment 5 in Region 1. In this example, the control plane VCN 616, or Deployment 5 in Region 1, may not be communicatively coupled to, or otherwise in communication with, Deployment 5 in Region 2.

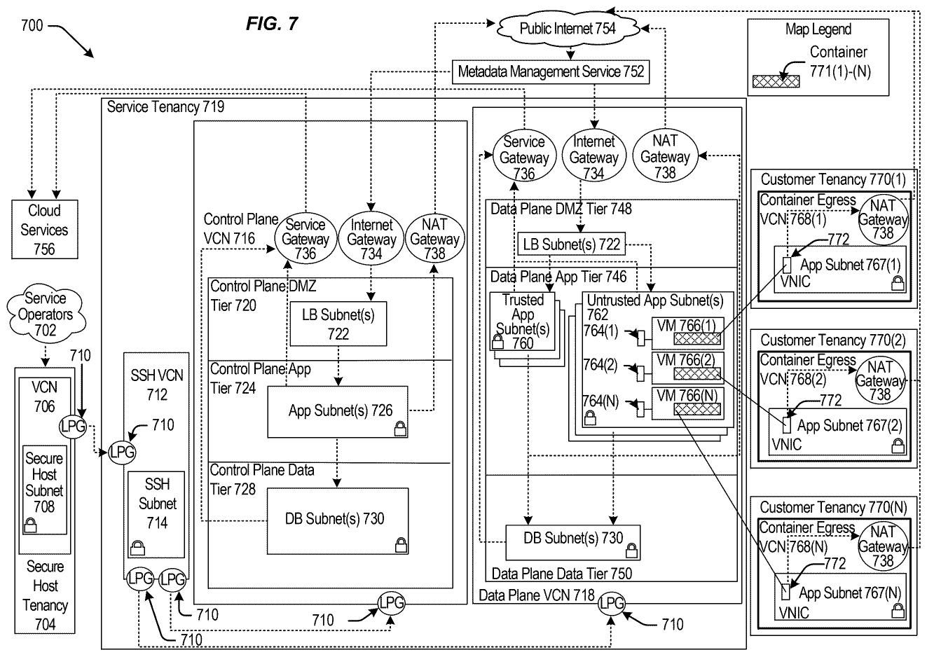

FIG. 7 is a block diagram 700 illustrating another example pattern of an IaaS architecture, according to at least one embodiment. Service operators 702 (e.g., service operators 502 of FIG. 5) can be communicatively coupled to a secure host tenancy 704 (e.g., the secure host tenancy 504 of FIG. 5) that can include a virtual cloud network (VCN) 706 (e.g., the VCN 506 of FIG. 5) and a secure host subnet 708 (e.g., the secure host subnet 508 of FIG. 5). The VCN 706 can include an LPG 710 (e.g., the LPG 510 of FIG. 5) that can be communicatively coupled to an SSH VCN 712 (e.g., the SSH VCN 512 of FIG. 5) via an LPG 710 contained in the SSH VCN 712. The SSH VCN 712 can include an SSH subnet 714 (e.g., the SSH subnet 514 of FIG. 5), and the SSH VCN 712 can be communicatively coupled to a control plane VCN 716 (e.g., the control plane VCN 516 of FIG. 5) via an LPG 710 contained in the control plane VCN 716 and to a data plane VCN 718 (e.g., the data plane 518 of FIG. 5) via an LPG 710 contained in the data plane VCN 718. The control plane VCN 716 and the data plane VCN 718 can be contained in a service tenancy 719 (e.g., the service tenancy 519 of FIG. 5).

The control plane VCN 716 can include a control plane DMZ tier 720 (e.g., the control plane DMZ tier 520 of FIG. 5) that can include load balancer (LB) subnet(s) 722 (e.g., LB subnet(s) 522 of FIG. 5), a control plane app tier 724 (e.g., the control plane app tier 524 of FIG. 5) that can include app subnet(s) 726 (e.g., similar to app subnet(s) 526 of FIG. 5), a control plane data tier 728 (e.g., the control plane data tier 528 of FIG. 5) that can include DB subnet(s) 730. The LB subnet(s) 722 contained in the control plane DMZ tier 720 can be communicatively coupled to the app subnet(s) 726 contained in the control plane app tier 724 and to an Internet gateway 734 (e.g., the Internet gateway 534 of FIG. 5) that can be contained in the control plane VCN 716, and the app subnet(s) 726 can be communicatively coupled to the DB subnet(s) 730 contained in the control plane data tier 728 and to a service gateway 736 (e.g., the service gateway of FIG. 5) and a network address translation (NAT) gateway 738 (e.g., the NAT gateway 538 of FIG. 5). The control plane VCN 716 can include the service gateway 736 and the NAT gateway 738.

The data plane VCN 718 can include a data plane app tier 746 (e.g., the data plane app tier 546 of FIG. 5), a data plane DMZ tier 748 (e.g., the data plane DMZ tier 548 of FIG. 5), and a data plane data tier 750 (e.g., the data plane data tier 550 of FIG. 5). The data plane DMZ tier 748 can include LB subnet(s) 722 that can be communicatively coupled to trusted app subnet(s) 760 and untrusted app subnet(s) 762 of the data plane app tier 746 and the Internet gateway 734 contained in the data plane VCN 718. The trusted app subnet(s) 760 can be communicatively coupled to the service gateway 736 contained in the data plane VCN 718, the NAT gateway 738 contained in the data plane VCN 718, and DB subnet(s) 730 contained in the data plane data tier 750. The untrusted app subnet(s) 762 can be communicatively coupled to the service gateway 736 contained in the data plane VCN 718 and DB subnet(s) 730 contained in the data plane data tier 750. The data plane data tier 750 can include DB subnet(s) 730 that can be communicatively coupled to the service gateway 736 contained in the data plane VCN 718.

The untrusted app subnet(s) 762 can include one or more primary VNICs 764(1)-(N) that can be communicatively coupled to tenant virtual machines (VMs) 766(1)-(N). Each tenant VM 766(1)-(N) can be communicatively coupled to a respective app subnet 767(1)-(N) that can be contained in respective container egress VCNs 768(1)-(N) that can be contained in respective customer tenancies 770(1)-(N). Respective secondary VNICs 772(1)-(N) can facilitate communication between the untrusted app subnet(s) 762 contained in the data plane VCN 718 and the app subnet contained in the container egress VCNs 768(1)-(N). Each container egress VCNs 768(1)-(N) can include a NAT gateway 738 that can be communicatively coupled to public Internet 754 (e.g., public Internet 554 of FIG. 5).

The Internet gateway 734 contained in the control plane VCN 716 and contained in the data plane VCN 718 can be communicatively coupled to a metadata management service 752 (e.g., the metadata management system 552 of FIG. 5) that can be communicatively coupled to public Internet 754. Public Internet 754 can be communicatively coupled to the NAT gateway 738 contained in the control plane VCN 716 and contained in the data plane VCN 718. The service gateway 736 contained in the control plane VCN 716 and contained in the data plane VCN 718 can be communicatively coupled to cloud services 756.

In some embodiments, the data plane VCN 718 can be integrated with customer tenancies 770. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 746. Code to run the function may be executed in the VMs 766(1)-(N), and the code may not be configured to run anywhere else on the data plane VCN 718. Each VM 766(1)-(N) may be connected to one customer tenancy 770. Respective containers 771(1)-(N) contained in the VMs 766(1)-(N) may be configured to run the code. In this case, there can be a dual isolation (e.g., the containers 771(1)-(N) running code, where the containers 771(1)-(N) may be contained in at least the VM 766(1)-(N) that are contained in the untrusted app subnet(s) 762), which may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completion of running the code, the IaaS provider may kill or otherwise dispose of the containers 771(1)-(N).

In some embodiments, the trusted app subnet(s) 760 may run code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be contained in the VM 766(1)-(N) of each customer and that may run code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the service gateway 736. For example, a call to cloud services 756 from the control plane VCN 716 can include a request for a service that can communicate with the data plane VCN 718.

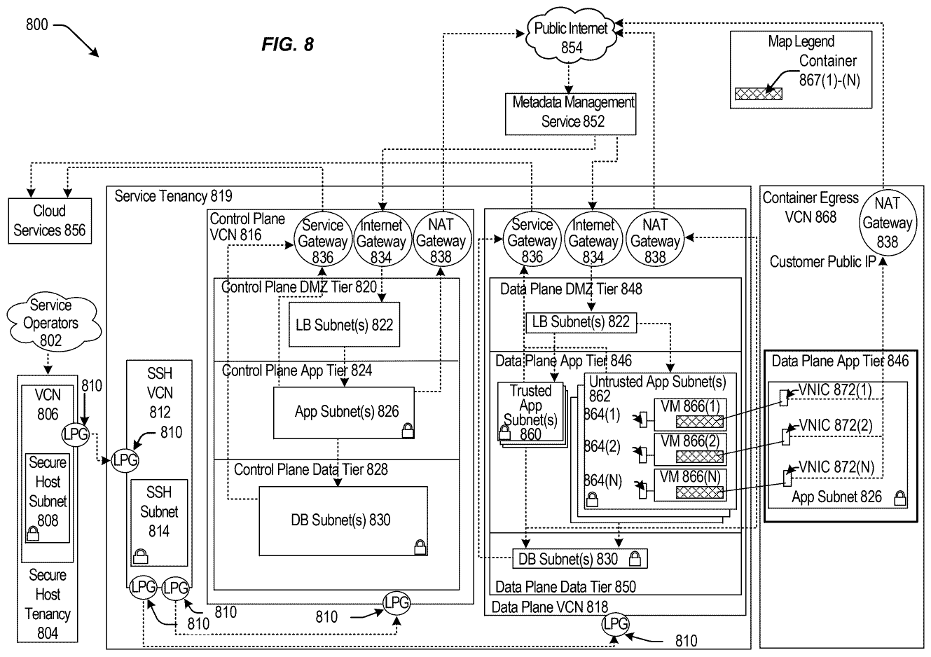

FIG. 8 is a block diagram 800 illustrating another example pattern of an IaaS architecture, according to at least one embodiment. Service operators 802 (e.g., service operators 502 of FIG. 5) can be communicatively coupled to a secure host tenancy 804 (e.g., the secure host tenancy 504 of FIG. 5) that can include a virtual cloud network (VCN) 806 (e.g., the VCN 506 of FIG. 5) and a secure host subnet 808 (e.g., the secure host subnet 508 of FIG. 5). The VCN 806 can include an LPG 810 (e.g., the LPG 510 of FIG. 5) that can be communicatively coupled to an SSH VCN 812 (e.g., the SSH VCN 512 of FIG. 5) via an LPG 810 contained in the SSH VCN 812. The SSH VCN 812 can include an SSH subnet 814 (e.g., the SSH subnet 514 of FIG. 5), and the SSH VCN 812 can be communicatively coupled to a control plane VCN 816 (e.g., the control plane VCN 516 of FIG. 5) via an LPG 810 contained in the control plane VCN 816 and to a data plane VCN 818 (e.g., the data plane 518 of FIG. 5) via an LPG 810 contained in the data plane VCN 818. The control plane VCN 816 and the data plane VCN 818 can be contained in a service tenancy 819 (e.g., the service tenancy 519 of FIG. 5).

The control plane VCN 816 can include a control plane DMZ tier 820 (e.g., the control plane DMZ tier 520 of FIG. 5) that can include LB subnet(s) 822 (e.g., LB subnet(s) 522 of FIG. 5), a control plane app tier 824 (e.g., the control plane app tier 524 of FIG. 5) that can include app subnet(s) 826 (e.g., app subnet(s) 526 of FIG. 5), a control plane data tier 828 (e.g., the control plane data tier 528 of FIG. 5) that can include DB subnet(s) 830 (e.g., DB subnet(s) 730 of FIG. 7). The LB subnet(s) 822 contained in the control plane DMZ tier 820 can be communicatively coupled to the app subnet(s) 826 contained in the control plane app tier 824 and to an Internet gateway 834 (e.g., the Internet gateway 534 of FIG. 5) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 5) and a network address translation (NAT) gateway 838 (e.g., the NAT gateway 538 of FIG. 5). The control plane VCN 816 can include the service gateway 836 and the NAT gateway 838.

The data plane VCN 818 can include a data plane app tier 846 (e.g., the data plane app tier 546 of FIG. 5), a data plane DMZ tier 848 (e.g., the data plane DMZ tier 548 of FIG. 5), and a data plane data tier 850 (e.g., the data plane data tier 550 of FIG. 5). The data plane DMZ tier 848 can include LB subnet(s) 822 that can be communicatively coupled to trusted app subnet(s) 860 (e.g., trusted app subnet(s) 760 of FIG. 7) and untrusted app subnet(s) 862 (e.g., untrusted app subnet(s) 762 of FIG. 7) of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include primary VNICs 864(1)-(N) that can be communicatively coupled to tenant virtual machines (VMs) 866(1)-(N) residing within the untrusted app subnet(s) 862. Each tenant VM 866(1)-(N) can run code in a respective container 867(1)-(N), and be communicatively coupled to an app subnet 826 that can be contained in a data plane app tier 846 that can be contained in a container egress VCN 868. Respective secondary VNICs 872(1)-(N) can facilitate communication between the untrusted app subnet(s) 862 contained in the data plane VCN 818 and the app subnet contained in the container egress VCN 868. The container egress VCN can include a NAT gateway 838 that can be communicatively coupled to public Internet 854 (e.g., public Internet 554 of FIG. 5).

The Internet gateway 834 contained in the control plane VCN 816 and contained in the data plane VCN 818 can be communicatively coupled to a metadata management service 852 (e.g., the metadata management system 552 of FIG. 5) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively coupled to cloud services 856.

In some examples, the pattern illustrated by the architecture of block diagram 800 of FIG. 8 may be considered an exception to the pattern illustrated by the architecture of block diagram 700 of FIG. 7 and may be desirable for a customer of the IaaS provider if the IaaS provider cannot directly communicate with the customer (e.g., a disconnected region). The respective containers 867(1)-(N) that are contained in the VMs 866(1)-(N) for each customer can be accessed in real-time by the customer. The containers 867(1)-(N) may be configured to make calls to respective secondary VNICs 872(1)-(N) contained in app subnet(s) 826 of the data plane app tier 846 that can be contained in the container egress VCN 868. The secondary VNICs 872(1)-(N) can transmit the calls to the NAT gateway 838 that may transmit the calls to public Internet 854. In this example, the containers 867(1)-(N) that can be accessed in real-time by the customer can be isolated from the control plane VCN 816 and can be isolated from other entities contained in the data plane VCN 818. The containers 867(1)-(N) may also be isolated from resources from other customers.

In other examples, the customer can use the containers 867(1)-(N) to call cloud services 856. In this example, the customer may run code in the containers 867(1)-(N) that requests a service from cloud services 856. The containers 867(1)-(N) can transmit this request to the secondary VNICs 872(1)-(N) that can transmit the request to the NAT gateway that can transmit the request to public Internet 854. Public Internet 854 can transmit the request to LB subnet(s) 822 contained in the control plane VCN 816 via the Internet gateway 834. In response to determining the request is valid, the LB subnet(s) can transmit the request to app subnet(s) 826 that can transmit the request to cloud services 856 via the service gateway 836.

It should be appreciated that IaaS architectures 500, 600, 700, 800 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

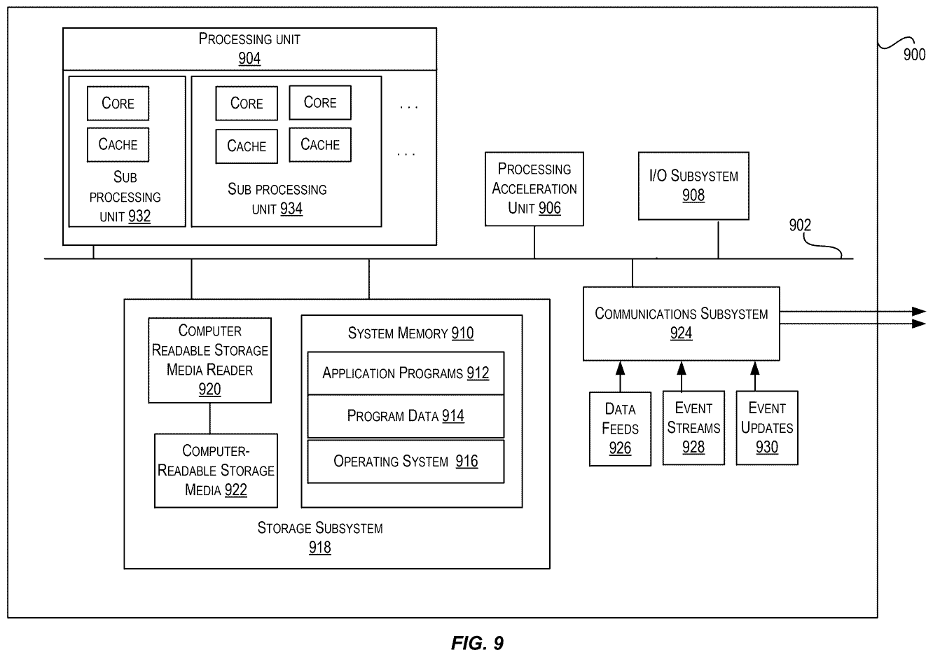

FIG. 9 illustrates an example computer system 900, in which various embodiments may be implemented. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that provides a tangible non-transitory computer-readable storage medium for storing software and data constructs that provide the functionality of the embodiments described in this disclosure. The software can include programs, code, instructions, scripts, etc., that when executed by one or more cores or processors of processing unit 904 provide the functionality described above. Storage subsystem 918 may also provide a repository for storing data used in accordance with the present disclosure.

As depicted in the example in FIG. 9, storage subsystem 918 can include various components including a system memory 910, computer-readable storage media 922, and a computer readable storage media reader 920. System memory 910 may store program instructions that are loadable and executable by processing unit 904. System memory 910 may also store data that is used during the execution of the instructions and/or data that is generated during the execution of the program instructions. Various different kinds of programs may be loaded into system memory 910 including but not limited to client applications, Web browsers, mid-tier applications, relational database management systems (RDBMS), virtual machines, containers, etc.

System memory 910 may also store an operating system 916. Examples of operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 900 executes one or more virtual machines, the virtual machines along with their guest operating systems (GOSs) may be loaded into system memory 910 and executed by one or more processors or cores of processing unit 904.

System memory 910 can come in different configurations depending upon the type of computer system 900. For example, system memory 910 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 910 may include a basic input/output system (BIOS) containing basic routines that help to transfer information between elements within computer system 900, such as during start-up.

Computer-readable storage media 922 may represent remote, local, fixed, and/or removable storage devices plus storage media for temporarily and/or more permanently containing, storing, computer-readable information for use by computer system 900 including instructions executable by processing unit 904 of computer system 900.

Computer-readable storage media 922 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program services, and other data for computer system 900.

Machine-readable instructions executable by one or more processors or cores of processing unit 904 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
obtaining, by a message broker service executing in a computing environment, quality of service metrics, the message broker service comprising a plurality of message broker instances;
determining, by the message broker service and based at least in part on the quality of service metrics, a number of message broker instances to send messages to subscribing clients;
determining, by the message broker service, whether the number of message broker instances exceeds the plurality of message broker instances; and
based at least in part on a determination that the number of message broker instances exceeds the plurality of message broker instances, executing, by the message broker service, the number of message broker instances.

2. The method of claim 1, wherein determining the number of message broker instances comprises evaluating a cost function taking the quality of service metrics as inputs.

3. The method of claim 2, wherein the cost function comprises a plurality of model parameters, and further comprising updating the model parameters using gradient descent with the quality of service metrics.

4. The method of claim 1, wherein the quality of service metrics comprise at least one of a message queue value, a message send delay value, or a message acknowledgement delay value.

5. The method of claim 1, wherein the message broker instances execute in one or more computing cluster nodes, the computing cluster nodes managed by a container management engine.

6. The method of claim 1, wherein executing the number of message broker instances comprises executing additional message broker instances corresponding to a difference between the number of message broker instances and the plurality of message broker instances.

7. The method of claim 1, wherein executing the number of message broker instances comprises removing excess message broker instances corresponding to a difference between the plurality of message broker instances and the number of message broker instances.

8. A distributed computing system, comprising:
one or more processors; and
one or more memories storing computer-executable instructions that, when executed by the one or more processors, cause the distributed computing system to:
obtain, by a message broker service executing in the distributed computing system, quality of service metrics, the message broker service comprising a plurality of message broker instances;
determine, by the message broker service and based at least in part on the quality of service metrics, a number of message broker instances to send messages to subscribing clients;
determine, by the message broker service, whether the number of message broker instances exceeds the plurality of message broker instances; and
based at least in part on a determination that the number of message broker instances exceeds the plurality of message broker instances, execute, by the message broker service, the number of message broker instances.

9. The distributed computing system of claim 8, wherein determining the number of message broker instances comprises evaluating a cost function taking the quality of service metrics as inputs.

10. The distributed computing system of claim 9, wherein the cost function comprises a plurality of model parameters, and wherein the one or more memories store further instructions that, when executed by the one or more processors, cause the distributed computing system to further update the model parameters using gradient descent with the quality of service metrics.

11. The distributed computing system of claim 8, wherein the quality of service metrics comprise at least one of a message queue value, a message send delay value, or a message acknowledgement delay value.

12. The distributed computing system of claim 8, wherein the message broker instances execute in one or more computing cluster nodes, the computing cluster nodes managed by a container management engine.

13. The distributed computing system of claim 8, wherein executing the number of message broker instances comprises executing additional message broker instances corresponding to a difference between the number of message broker instances and the plurality of message broker instances.

14. The distributed computing system of claim 8, wherein executing the number of message broker instances comprises removing excess message broker instances corresponding to a difference between the plurality of message broker instances and the number of message broker instances.

15. A non-transitory computer-readable medium comprising executable instructions that, when executed by one or more processors of a distributed computing system, cause the distributed computing system to:
obtain, by a message broker service executing in the distributed computing system, quality of service metrics, the message broker service comprising a plurality of message broker instances;
determine, by the message broker service and based at least in part on the quality of service metrics, a number of message broker instances to send messages to subscribing clients;
determine, by the message broker service, whether the number of message broker instances exceeds the plurality of message broker instances; and
based at least in part on a determination that the number of message broker instances exceeds the plurality of message broker instances, execute, by the message broker service, the number of message broker instances.

16. The non-transitory computer-readable medium of claim 15, wherein determining the number of message broker instances comprises evaluating a cost function taking the quality of service metrics as inputs.

17. The non-transitory computer-readable medium of claim 16, wherein the cost function comprises a plurality of model parameters, and comprising further instructions that, when executed by the one or more processors, cause the distributed computing system to further update the model parameters using gradient descent with the quality of service metrics.

18. The non-transitory computer-readable medium of claim 15, wherein the message broker instances execute in one or more computing cluster nodes, the computing cluster nodes managed by a container management engine.

19. The non-transitory computer-readable medium of claim 15, wherein executing the number of message broker instances comprises executing additional message broker instances corresponding to a difference between the number of message broker instances and the plurality of message broker instances.

20. The non-transitory computer-readable medium of claim 15, wherein executing the number of message broker instances comprises removing excess message broker instances corresponding to a difference between the plurality of message broker instances and the number of message broker instances.
